(19) United States
(12) Patent Application Publication
(10) Pub. No.: US 2008/0094710 A1
(43) Pub. Date: Apr. 24, 2008

(54) Fresnel Zone Plate and X-Ray Microscope Using the Fresnel Zone Plate

(75) Inventor: Hisamitsu Endoh, Kusatsu-shi (JP)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: KYOTO INSTITUTE OF TECHNOLOGY, Kyoto (JP)

(21) Appl. No.: 11/950,916

(22) Filed: Dec. 5, 2007

Related U.S. Application Data
(63) Continuation-in-part of application No. 11/912,013.

(30) Foreign Application Priority Data
Apr. 20, 2005 (JP) P2005-121990

(51) Int. Cl. G02B 27/44

(52) U.S. Cl. 359/565

(57) ABSTRACT

[Object] To provide a Fresnel's zone plate having a complex illumination function capable of improving resolution even when the outermost opaque band width cannot be reduced and an X-ray microscope using the Fresnel's zone plate.

[Solution] A Fresnel's zone plate 1 having a complex illumination function according to the invention has opaque bands 3 and transparent bands 4 arranged alternately in the radial direction from the center concentrically on a flat transparent substrate 2, and a transmission window 7 formed such that a portion of a plane wave vertically applied onto the upper surface vertically enters directly a sample 6 disposed below the Fresnel's zone plate 1 without dispersion.

### TECHNICAL FIELD

The present invention relates to a Fresnel's zone plate having a complex illumination function in which opaque bands and transparent bands are arranged alternately in the radial direction from the center of a transparent substrate, and to an X-ray microscope with no objective lens, using such a Fresnel's zone plate as a complex illumination lens.

### BACKGROUND ART

In X-ray microscopes of the type that obtains a high-resolution transmission image of an object using X-ray source, there is known one that uses a Fresnel's zone plate as an objective lens (see Patent Document 1, for example).

The Fresnel's zone plate is produced by forming a group of a plurality of concentric circles so that the diameter Rn of an n-th circle counted from the center is proportional to the square root of n on a transparent substrate that transmits X-ray, and arranging opaque bands (black circles) and transparent bands (white circles) alternately in the radial direction from the center, as shown in FIG. 19, and functions as a lens member which is very effective for X-ray region.

In such a Fresnel's zone plate, it is possible to increase the resolution by decreasing the width of the outermost opaque band (the outermost zone width), and a Fresnel's zone plate having resolution in the order of 1 μm is available at present as a result of development in fine processing technique.

Patent Document 1: Japanese Laid-Open Patent Publication No. 10-104400

### DISCLOSURE OF THE INVENTION

### Problem to be Solved by the Invention

However, because of the limitation of fine processing technique in production of a Fresnel's zone plate, it was still difficult to obtain an image of such high resolution as exceeding 1 μm only by decreasing the width of the outermost opaque band of the Fresnel's zone plate.

In an optical system of an X-ray microscope using a conventional Fresnel's zone plate, since a Fresnel's zone plate for focusing is arranged directly before a sample and an observation area of the sample is covered, a plane wave emitted from the Fresnel's zone plate is used as a sample illumination wave for illuminating the sample. In other words, conventional Fresnel's zone plates lack the function of illuminating a sample with a plane wave with no phase turbulence while illuminating a recording surface of the X-ray microscope with a plane wave (reference wave) emitted from the Fresnel's zone plate (complex illumination function). Therefore, conventionally, a portion of a plane wave disturbed by the Fresnel's zone plate is used as a sample illumination wave, which is also one factor of making it difficult to obtain an image of high resolution.

The present invention was made in light of the above problems, and it is an object of the present invention to provide a Fresnel's zone plate having a complex illumination function capable of improving resolution even when the outermost opaque band width cannot be reduced and an X-ray microscope with no objective lens, using the Fresnel's zone plate as a complex illumination lens.

### Means for Solving the Problem

In order to achieve the above object, a Fresnel zone plate according to claim 1 having a complex illumination function is characterized in that a transmission window is formed in the Fresnel zone plate such that a portion of a plane wave vertically applied onto the upper surface of the Fresnel zone plate directly and vertically enters a sample disposed below the Fresnel zone plate without being disturbed by the Fresnel zone plate, the Fresnel zone plate being formed by concentrically arranging an opaque band and a transparent band alternately in a radial direction from the center on a flat transparent substrate.

A Fresnel zone plate according to claim 2 having a complex illumination function is characterized in that a portion of the Fresnel zone plate is excised in an axial direction such that a portion of a plane wave vertically applied onto the upper surface of the Fresnel zone plate directly and vertically enters a sample disposed below the Fresnel zone plate without being disturbed by the Fresnel zone plate, the Fresnel zone plate being formed by concentrically arranging an opaque band and a transparent band alternately in a radial direction from the center on a flat transparent substrate.

A Fresnel zone plate according to claim 3 having a complex illumination function is characterized in that a transmission window is formed in the Fresnel's zone plate and a portion of the Fresnel's zone plate is excised in an axial direction such that a portion of a plane wave vertically applied onto the upper surface of the Fresnel's zone plate directly and vertically enters a sample disposed below the Fresnel's zone plate without being disturbed by the Fresnel's zone plate, the Fresnel's zone plate being formed by concentrically arranging an opaque band and a transparent band alternately in a radial direction from the center on a flat transparent substrate.

The Fresnel's zone plate having a complex illumination function according to claim 1 or 3, wherein the transmission window is formed by not disposing the opaque band.

The Fresnel's zone plate having a complex illumination function according to claim 1 or 3, wherein the transmission window is formed by providing a face-excised portion in the transparent substrate.

The Fresnel's zone plate having a complex illumination function according to any one of claims 1, 3, 4 and 5, wherein the transmission window is polygonal.

The Fresnel's zone plate having a complex illumination function according to any one of claims 1, 3, 4 and 5, wherein the transmission window is circular.

The Fresnel's zone plate having a complex illumination function according to any one of claims 1, 3, and 4 to 7, wherein two or more transmission windows are formed.

The Fresnel's zone plate having a complex illumination function according to claim 1 or 3, wherein two or more transmission windows are formed, and at least one of the transmission windows is formed by not disposing the opaque band while at least one of the transmission windows is formed by providing a face-excised portion in the transparent substrate.

The Fresnel's zone plate having a complex illumination function according to claim 1 or 3, wherein two or more transmission windows are formed, and at least one of the transmission windows is polygonal while at least one of the transmission windows is circular.

The Fresnel's zone plate having a complex illumination function according to claim 1 or 3, wherein two or more transmission windows are formed, at least one of the transmission windows is formed by not disposing the opaque band while at least one of the transmission windows is formed by providing a face-excised portion in the transparent substrate, and at least one of the transmission windows is polygonal while at least one of the transmission windows is circular.

The Fresnel's zone plate having a complex illumination function according to claim 2 or 3, wherein the excised portion of the Fresnel's zone plate is an approximately half of the Fresnel's zone plate that is zoned by a straight line passing through the approximate center of the Fresnel's zone plate.

The Fresnel's zone plate having a complex illumination function according to claim 2 or 3, wherein the excised portion of the Fresnel's zone plate is a part of the Fresnel's zone plate that is zoned by a polygon including a part of a circumference of the Fresnel's zone plate.

The Fresnel's zone plate having a complex illumination function according to claim 2 or 3, wherein the excised portion of the Fresnel's zone plate is a part of the Fresnel's zone plate that is zoned by a part of a circumference of the Fresnel's zone plate and a circular arc.

The Fresnel's zone plate having a complex illumination function according to any one of claims 2, 3, 13 and 14, wherein portions of the Fresnel's zone plate are excised in two or more positions.

The Fresnel's zone plate having a complex illumination function according to claim 2 or 3, wherein portions of the Fresnel's zone plate are excised in two or more positions, and at least one of the excised portions is a part of the Fresnel's zone plate that is zoned by a polygon including a part of a circumference of the Fresnel's zone plate while at least one of the excised portions is a part of the Fresnel's zone plate that is zoned by a part of the circumference of the Fresnel's zone plate and a circular arc.

An X-ray microscope with no objective lens, using one or more Fresnel's zone plate(s) each having a complex illumination function according to any one of claims 1 to 16 as a complex illumination lens.

### EFFECT OF THE INVENTION

According to the invention of claim 1, by forming a transmission window in the Fresnel's zone plate, it is possible to allow a perfect plane wave with no phase turbulence (for example, a plane wave of soft X-ray) to vertically enter a sample disposed below the Fresnel's zone plate. Therefore, the phase of the plane wave entering the sample has no turbulence as in the case of using a Fresnel's zone plate of the type that makes a portion of a wave emitted from the Fresnel's zone plate enter the sample as a plane wave. As a result, it is possible to improve the resolution without reducing the width of the outermost opaque band of the Fresnel's zone plate. Therefore, it is possible to obtain an image of such high resolution as exceeding 0.1 μm by reducing the width of the outermost opaque band as small as possible, and forming a transmission window.

According to the invention of claim 2, by excising a portion of the Fresnel's zone plate in the axial direction, it is possible to allow a perfect plane wave with no phase turbulence to vertically enter a sample disposed below the Fresnel's zone plate. Therefore, as in the above case, no phase turbulence occurs in the plane wave entering the sample, so that it is possible to improve the resolution without reducing the width of the outermost opaque band. Therefore, by reducing the width of the outermost opaque band as small as possible and making the plane wave enter the Fresnel's zone plate and the region created by excising a portion of the Fresnel's zone plate, it is possible to obtain an image of such high resolution as exceeding 0.1 μm.

According to the invention of claim 3, by forming a transmission window in the Fresnel's zone plate and excising a portion of the Fresnel's zone plate in the axial direction, it is possible to allow a perfect plane wave with no phase turbulence to vertically enter a sample disposed below the Fresnel's zone plate. Therefore, likewise the above, the phase of the plane wave entering the sample has no turbulence, so that it is possible to improve the resolution without reducing the width of the outermost opaque band. Therefore, by reducing the width of the outermost opaque band as small as possible and making the plane wave enter the Fresnel's zone plate and the region created by excising a portion of the Fresnel's zone plate, it is possible to obtain an image of such high resolution as exceeding 0.1 μm.

According to the invention of claim 4, the transmission window is formed by not disposing an opaque band. Therefore, it is possible to easily form the transmission window.

According to the invention of claim 5, the transmission window is formed by providing a face-excised portion in the transparent substrate. Therefore, it is possible to reduce the production cost by reducing the material for the transparent substrate required for production of the Fresnel's zone plate.

According to the invention of claim 6, the transmission window is in a polygonal shape. Therefore, the shape of the transmission window may be appropriately adapted to the shape of the sample.

According to the invention of claim 7, the transmission window is in a circular shape. Therefore, it is possible to easily form the transmission window.

According to the invention of claim 8, two or more transmission windows are formed. Therefore, it is possible to allow a perfect plane wave with no phase turbulence to vertically enter two or more samples, or two or more positions in a sample.

According to the invention of claim 9, two or more transmission windows are formed, and at least one of the transmission windows is formed by not disposing an opaque band while at least one of the transmission windows is formed by providing a face-excised portion in the transparent substrate. Therefore, it is possible to allow a perfect plane wave with no phase turbulence to vertically enter two or more samples, or two or more positions in a sample; it is possible to easily form the transmission window; and it is possible to reduce the production cost by reducing the material for the transparent substrate required for production of the Fresnel's zone plate.

According to the invention of claim 10, two or more transmission windows are formed, and at least one of the transmission windows is polygonal while at least one of the transmission windows is circular. Therefore, it is possible to allow a perfect plane wave with no phase turbulence to vertically enter two or more samples, or two or more positions in a sample; the shape of the transmission window may be appropriately adapted to the shape of the sample; and it is possible to easily form the transmission window.

According to the invention of claim 11, two or more transmission windows are formed, at least one of the transmission windows is formed by not disposing an opaque band while at least one of the transmission windows is formed by providing a face-excised portion in the transparent substrate, and at least one of the transmission windows is polygonal while at least one of the transmission windows is circular. Therefore, it is possible to allow a perfect plane wave with no phase turbulence to vertically enter two or more samples, or two or more positions in a sample. Also, it is possible to easily form the transmission window; it is possible to reduce the production cost by reducing the material for the transparent substrate required for production of the Fresnel's zone plate; the shape of the transmission window may be appropriately adapted to the shape of the sample; and it is possible to easily form the transmission window.

According to the invention of claim 12, the excised portion of the Fresnel's zone plate is approximately a half of the Fresnel's zone plate that is zoned by a straight line passing the approximate center of the Fresnel's zone plate. Therefore, the excised Fresnel's zone plate may also be used as a complex illumination lens for an X-ray microscope. In other words, two Fresnel's zone plates having higher resolution can be produced from one Fresnel's zone plate, so that the production cost for the Fresnel's zone plates can be reduced. Also, production of the Fresnel's zone plate is facilitated compared to the case where a transmission window is formed in the Fresnel's zone plate.

According to the invention of claim 13, the excised portion of the Fresnel's zone plate is a part of the Fresnel's zone plate that is zoned by a polygon including a part of circumference of the Fresnel's zone plate. Therefore, it is possible to appropriately allow a perfect plane wave with no phase turbulence to vertically enter the sample in accordance with the shape of the sample.

According to the invention of claim 14, the excised portion of the Fresnel's zone plate is a part of the Fresnel's zone plate that is zoned by a part of the circumference of the Fresnel's zone plate and a circular arc. Therefore, it is possible to easily produce the Fresnel's zone plate.

According to the invention of claim 15, portions of the Fresnel's zone plate are excised in two or more positions. Therefore, it is possible to allow a perfect plane wave with no phase turbulence to vertically enter two or more samples, or two or more positions in a sample.

According to the invention of claim 16, portions of the Fresnel's zone plate are excised in two or more positions, and at least one of the excised portions is a part of the Fresnel's zone plate that is zoned by a polygon including a part of the circumference of the Fresnel's zone plate while at least one of the excised portions is a part of the Fresnel's zone plate that is zoned by a part of the circumference of the Fresnel's zone plate and a circular arc. Therefore, it is possible to allow a perfect plane wave with no phase turbulence to vertically enter two or more samples, or two or more positions in a sample. Also, it is possible to appropriately allow a perfect plane wave with no phase turbulence to vertically enter the sample in accordance with the shape of the sample, and it is possible to easily produce the Fresnel's zone plate.

According to the invention of claim 17, there is provided an X-ray microscope with no objective lens, using a Fresnel's zone plate having a complex illumination function according to any one of claims 1 to 16 as a complex illumination lens. Therefore, it is possible to obtain an image of such high resolution as exceeding 0.1 μm.

By designing the portion to be excised to be substantially a half of the Fresnel zone plate, the excised Fresnel zone plate may also be used as a complex illumination lens of the X-ray microscope. In other words, two Fresnel zone plates having higher resolution can be produced from one Fresnel zone plate, so that the production cost of Fresnel zone plates can be reduced. This is also advantageous in that production of Fresnel zone plate is facilitated compared to the case where a transmission window is formed in the Fresnel zone plate.

### BEST MODE FOR CARRYING OUT THE INVENTION

In the following, embodiments of the present invention will be described based on the attached drawings. FIG. 1 (a) is a plan view of a Fresnel's zone plate (FZP) 1 having a complex illumination function according an embodiment of the present invention, FIG. 1 (b) is a sectional view taken along the line A-A of FIG. 1 (a). The Fresnel's zone plate having the complex illumination function (hereinafter, simply referred to as “Fresnel's zone plate”) 1 is constructed by forming a group of a plurality of concentric circles so that the diameter Rn of an n-th circle counted from the center is proportional to the square root of n on a flat transparent substrate 2 that transmits X-ray, and arranging opaque bands 3 and transparent bands 4 alternately in the radial direction from the center concentrically, as shown in the figure. The positional relationship between the opaque bands 3 and the transparent bands 4 may be inverse without limited to the example shown in FIG. 1. That is, the transparent bands 4 may be positioned in the center of the Fresnel's zone plate 1. The term “complex illumination function” used herein refers to a function of illuminating a sample with a plane wave with no phase turbulence while illuminating a recording surface of an X-ray microscope with a plane wave (reference wave) emitted from the Fresnel's zone plate.

The transparent substrate 2 is made of a material that easily transmits X-ray, for example, SiN (silicon nitride). The shape and dimension of the transparent substrate 2 are not particularly limited, however, in the present embodiment, it is formed into a flat-plate shape having a circular cross section in the horizontal direction, measuring about 0.625 mm in diameter, and about 0.5 μm in thickness.

The opaque bands 3 are portions that fail to transmit X-ray and the like, and are formed on the transparent substrate 2, for example, by arranging flat plates of Ta concentrically. In the present example, the innermost radius (radius of inner most opaque band 3) is about 7.071 μm, the zone number (total of the number of opaque bands 3 and the number of transparent bands 4) is about 1952, and the zone width of the outermost shell (line width of the outermost opaque band 3) is about 80 nm so as to improve the resolution. The material that forms the opaque bands 3 is not particularly limited, and any material may be used instead of Ta insofar as it does not transmit X-ray. The Fresnel's zone plate 1 may be produced by fine processing techniques (for example, sputtering deposition, ion beam sputtering, electron beam lithography).

In the following, description will be made for an optical system of an X-ray microscope 5 with no objective lens that uses the Fresnel's zone plate 1 as a complex illumination lens. The description centers on principal elements of the X-ray microscope 5 according to an embodiment of the present invention while omitting description for the elements that are essentially provided in a general X-ray microscope.

FIG. 2 is a diagram schematically showing a Fourier transform holography imaging optical system of the X-ray microscope 5 using the Fresnel's zone plate 1 according to an embodiment of the present invention as a complex illumination lens. The term “complex illumination lens” used herein refers to the illumination lens having a function of simultaneously emitting a plane wave and a plane wave, namely illuminating a recording surface of an X-ray microscope with a plane wave as a reference wave while illuminating a sample with a plane wave with no phase turbulence.

The X-ray microscope 5 obtains a high-resolution transmission image of an object by using soft X-ray which inflicts little damage on biological samples and has a facility of observing an organism with high resolution and no dying, as an optical source, and the Fresnel's zone plate 1 as a complex illumination lens. As shown in the figure, as to the Fresnel's zone plate 1 used as a complex illumination lens by the X-ray microscope 5, the Fresnel's zone plate 1 is provided with a transmission window 7 so that a portion of a plane wave of soft X-ray vertically applied onto the upper surface of the Fresnel's zone plate 1 will directly and vertically enter a sample 6 disposed below the Fresnel's zone plate 1 without being disturbed by the Fresnel's zone plate 1. The transmission window 7, the size of which is not particularly limited, is formed in accordance with the size of the sample 6 disposed below the Fresnel's zone plate 1. In other words, it is formed into such a size that allows a portion of the plane wave vertically applied from above the Fresnel's zone plate 1 to directly and vertically enter the entire upper surface of the sample 6 without being disturbed under the influence of the Fresnel's zone plate 1.

As shown in FIG. 1, the transmission window 7 is preferably formed in such a manner that a face-excised portion of the transmission window 7 is formed by excision from the conventional Fresnel's zone plate shown in FIG. 19, or the Fresnel's zone plate 1 is formed and processed so that a face-excised portion of the transmission window 7 is formed in advance. However, the transmission window 7 is not limited to that formed by excision of the Fresnel's zone plate, and the transmission window 7 may be formed in such a manner that the opaque band 3 is not formed in the portion corresponding to the transmission window 7 by fine processing technique as described above, or the portion once formed may be removed. These are also embraced in the present invention. The transmission window 7 is not limited to those described above as far as it is formed to enable a plane wave to vertically enter the sample 6 disposed below the Fresnel's zone plate.

The X-ray microscope 5 has a plate supporting member (not illustrated) for supporting the Fresnel's zone plate 1 serving as a complex illumination lens, and is able to finely adjust the position of the Fresnel's zone plate 1 in the vertical, back-and-forth, and horizontal directions by displacing the plate supporting member.

Also below the Fresnel's zone plate 1, a sample stage 8 for supporting the sample 6 is provided, and by displacing the sample stage 8, the position of the sample 6 can be finely adjusted in the vertical, back-and-forth, and horizontal directions.

Therefore, a user can easily conduct horizontal positioning of the transmission window 7 of the Fresnel's zone plate 1 and the sample 6 on the sample stage 8 by displacing either one or both of the plate supporting part and the sample stage 8.

After positioning the transmission window 7 of the Fresnel's zone plate 1 and the sample stage 8 in this manner, a plane wave of X-ray (soft X-ray) is vertically applied to the upper surface of the Fresnel's zone plate 1 from an optical source which is not illustrated (for example, from a synchrotron optical source having strong directivity), then the plane wave is focused by the Fresnel's zone plate 1, and a point optical source 0 is formed by the focused waves emitted from the Fresnel's zone plate 1. The sample stage 8 is provided with a PH (pinhole) 9 by which diffracted waves of unnecessary orders are removed from the focused waves emitted from the Fresnel's zone plate 1. Then, a reference wave (spherical wave) 10 is emitted from the point optical source 0. The point optical source 0 is formed at the position where the distance from a recording surface (observation surface) 11 is equal to the distance from the recording surface 11 to the sample 6. As an optical source for illuminating the Fresnel's zone plate 1 with soft X-ray, a laser plasma source, an electron beam exciting X-ray tube and the like may be used. Further, application to an optical microscope is possible when visible light is used for the optical source.

On the other hand, the plane wave vertically applied to the transmission window 7 of the Fresnel's zone plate 1 runs straight via the transmission window 7 without being focused by the Fresnel's zone plate 1, and directly and vertically enters, as the sample illumination wave, the upper surface of the sample 6 which is disposed on the same plane as the point optical source 0 and at the same position as the transmission window 7 when seen horizontally. Then, an object wave (spherical wave) 12 is emitted from the sample 6.

Sequentially, the object wave 12 having passed the sample 6 and the reference wave 10 not having passed the sample 6 interfere with each other on the recording surface 11, so that interference fringes are formed on the recording surface 11. The sample 6 and the recording surface 11 are so arranged that complex amplitudes (phase and amplitude) of the object wave 12 and the reference wave 10 in the recording surface 11 are Fourier transform images of complex amplitudes of the sample 6 and the reference wave point optical source 0, respectively, or in other words, a Fourier transform holography optical system is formed. In this manner, a hologram is optically formed by recording information of the complex amplitude (phase and amplitude) of the object wave 12 on the recording surface 11 with the use of the interferential action of light wave.

Through one Fourier transform of the hologram thus obtained by application of the Fourier transform holographic method with the use of a computer not illustrated, an enlarged structure of the sample 6 can be reproduced.

FIG. 3 is a diagram exemplarily showing a Fourier transform holography imaging system using a conventional Fresnel's zone plate (FZP in the figure) as a beam splitter. This Fresnel's zone plate is produced in a similar manner to the Fresnel's zone plate 1 except that the transmission window 7 is not formed. In the illustrated optical system, the Fresnel's zone plate to which a plane wave of soft X-ray is vertically applied functions as a beam splitter, and from the Fresnel's zone plate, a plane wave (hereinafter, referred to as “transmitted 0-order light”) is emitted together with focused waves, and the emitted transmitted 0-order light vertically enters the sample as the sample illumination wave.

Now, the plane wave vertically entering the sample 6 shown in FIG. 2 and the transmitted 0-order light vertically entering the sample shown in FIG. 3 are compared. To the sample shown in FIG. 3, transmitted 0-order light whose phase is disturbed by the presence of the opaque band of the Fresnel's zone plate vertically enters as the sample reference wave, and to the sample shown in FIG. 2, a plane wave whose phase is not disturbed by the Fresnel's zone plate 1 vertically enters the sample 6 through the transmission window 7 in a perfect condition, as the sample illumination wave. As described above, in the conventional Fresnel's zone plate, since the transmitted O-order light having phase turbulence vertically enters the sample as the sample illumination wave, an adverse affect is exerted on the hologram formed on the recording surface and, as a result, the problem of deteriorating the resolution of a reproduced image arises.

Therefore, according to the Fresnel's zone plate 1, since the Fresnel's zone plate is made to function as a beam splitter, a plane wave having phase turbulence due to disturbance by the Fresnel's zone plate will not vertically enter the sample as is the case with the conventional X-ray microscope in which transmitted 0-order light having transmitted the Fresnel's zone plate vertically enters the sample as the sample illumination wave. Accordingly, an image having higher resolution compared with the case of using a conventional Fresnel's zone plate (reproduced image exceeding 0.1 μm) can be obtained.

In the present embodiment, description was made for the case where the transmission window 7 is formed by providing the transparent substrate 2 of the Fresnel's zone plate 1 with a face-excised portion, however, the face-excised portion may not be formed and the opaque band 3 may not be provided at the position corresponding to the sample 6 in the Fresnel's zone plate 1 so that a portion of the plane wave vertically applied to the upper surface of the Fresnel's zone plate 1 directly and vertically enters the sample 6 disposed below the Fresnel's zone plate 1 without being disturbed by the Fresnel's zone plate 1. In this case, however, since the plane wave vertically applied passes the transparent band 4, the phase may be disturbed more or less, to deteriorate the resolution. Therefore, it is more preferred to form the transmission window 7 as described in the present embodiment.

The position, shape, and number of the transmission window 7 are not limited to those of the example shown in FIG. 1. For example, the transmission window 7 may be in the polygonal shape such as a three or more-angular polygon as shown in FIG. 4, or may be in a circular shape as shown in FIG. 5. The number of the transmission window 7 may be two or more as shown in FIGS. 6 and 7, and the position of the transmission window 7 may be selected arbitrarily.

Next, description will be made on a Fresnel's zone plate 13 according to a modification of the embodiment described above. In the following description, different points are mainly described while those having the same structures as in the Fresnel's zone plate 1 are designated by the same reference numerals and description thereof will be omitted.

FIG. 8(a) is a plan view of the Fresnel's zone plate 13, FIG. 8 (b) is a sectional view taken along the line B-B of FIG. 8 (a), FIG. 9 is a diagram schematically showing a Fourier transform holography imaging optical system of an X-ray microscope 5 using the Fresnel's zone plate 13 as a complex illumination lens. As is illustrated, in the Fresnel's zone plate 13, a portion of the Fresnel's zone plate 13 is excised in the axial direction so that a portion of a plane wave vertically applied to the upper surface of the Fresnel's zone plate 13 will directly and vertically enter a sample 6 disposed below the Fresnel's zone plate 13 without being disturbed by the Fresnel's zone plate 13. Although FIGS. 8 and 9 show the Fresnel's zone plate 13 obtained by excising a substantially half of the Fresnel's zone plate as shown in FIG. 19 as the aforementioned portion, the dimension of the excised portion may be appropriately changed in accordance with the size of the sample 6.

The position, shape and number of the portion to be excised in the Fresnel's zone plate are not limited to those of the example shown in FIG. 8. For example, as shown in FIGS. 10 and 11, the portion to be excised may be the part that is zoned by a polygon including a part of the circumference of the Fresnel's zone plate, or may be the part that is zoned by a part of the circumference of the Fresnel's zone plate and a circular arc as shown in FIG. 12. Also, as shown in FIG. 13, the portion to be excised in the Fresnel's zone plate may be in two or more positions, and as shown in FIG. 14, the two or more portions to be excised may be a combination of the part that is zoned by a polygon including a part of the circumference of the Fresnel's zone plate and the part that is zoned by a part of the circumference of the Fresnel's zone plate and a circular arc.

The Fresnel's zone plate 13 may be obtained by excising a portion in the axial direction as described above, or by forming into a shape in which a portion of the Fresnel's zone plate is excised in advance; otherwise obtained in any methods without limited to the above methods insofar as it allows a plane wave to vertically enter the sample 6 disposed below the Fresnel's zone plate.

According to the present Fresnel's zone plate 13, it is possible to allow a perfect plane wave with no phase turbulence to vertically enter the sample 6 as in the case of the Fresnel's zone plate 1, so that an image of still higher resolution can be obtained in comparison with the conventional Fresnel's zone plate. Since the Fresnel's zone plate 13 can be fabricated by excising a portion of the Fresnel's zone plate in the axial direction (substantial half in the present embodiment) as described above, it can be fabricated easily and with lower cost compared to the Fresnel's zone plate 1 in which the transmission window 7 is formed.

When a substantial half of the Fresnel's zone plate is excised as described above, the portion excised for producing the Fresnel's zone plate 13 is substantially identical to the Fresnel's zone plate 13. In other words, it is possible to produce two Fresnel's zone plates 13 from one Fresnel's zone plate as shown in FIG. 19.

Further, the Fresnel's zone plate may be a Fresnel's zone plate 14 obtained by excising a part of the Fresnel's zone plate and forming the transmission window 7. That is, as shown in FIG. 15, a portion made by excising a part of the Fresnel's zone plate may be provided in one position, and the transmission window 7 may be provided in one position. As shown in FIG. 16, the transmission windows 7 may be provided in two or more positions. Alternatively, as shown in FIG. 17, the portions formed by excising parts of the Fresnel's zone plate may be provided in two or more positions and the transmission window 7 may be provided in one position, or as shown in FIG. 18, the portions formed by excising parts of the Fresnel's zone plate may be provided in two or more positions and the transmission windows 7 may be provided in two or more positions. In these cases, the portion formed by deleting a part of the Fresnel's zone plate may be not limited only to the portion that is zoned by a part of the circumference of the Fresnel's zone plate and a circular arc but may be the portion that is zoned by a polygon including a part of the circumference of the Fresnel's zone plate. Likewise, the shape of the transmission window 7 may be not limited only to a circle but may be a polygon.

Configurations of the Fresnel's zone plate 1, the Fresnel's zone plate 13 and the X-ray microscope 5 shown in the present embodiment are merely one aspect of the Fresnel's zone plate and X-ray microscope according to the present invention, and it goes without saying that the design may be appropriately changed without departing from the subject matter of the present invention, and may be realized, for example, as an optical microscope using a laser beam as an optical source. The X-ray microscope may use one of the Fresnel's zone plate 1, Fresnel's zone plate 13, and Fresnel's zone plate 14, or may use a plurality of the Fresnel's zone plates. In the latter case, the plurality of the Fresnel's zone plates may be those of different aspects.

### Industrial Applicability

The present invention is also applicable to an optical microscope using visible light as an optical source as well as to a Fresnel's zone plate and an X-ray microscope using the Fresnel's zone plate, for example.

### BRIEF DESCRIPTION OF THE DRAWINGS

FIG. 1 (a) is a plan view of a Fresnel's zone plate according to one embodiment of the present invention, and FIG. 1 (b) is a sectional view taken along the line A-A of FIG. 1 (a).

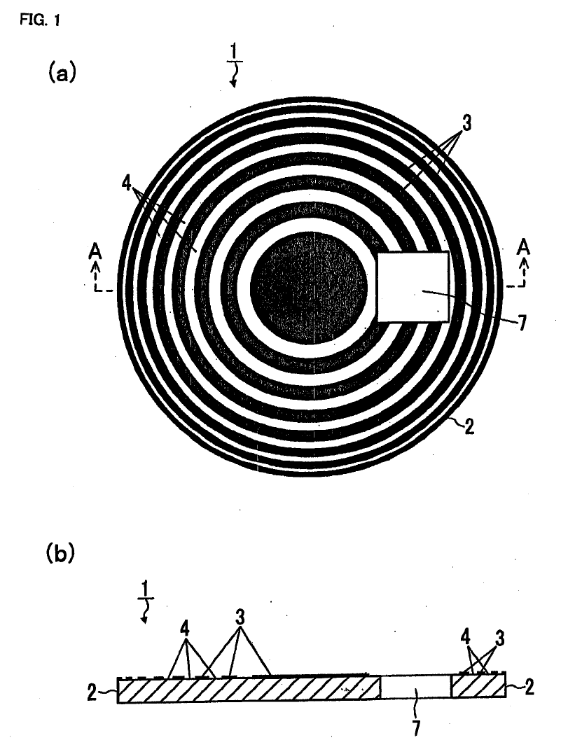

FIG. 2 is a diagram schematically showing an optical system of an X-ray microscope using the Fresnel's zone plate as a complex illumination lens.

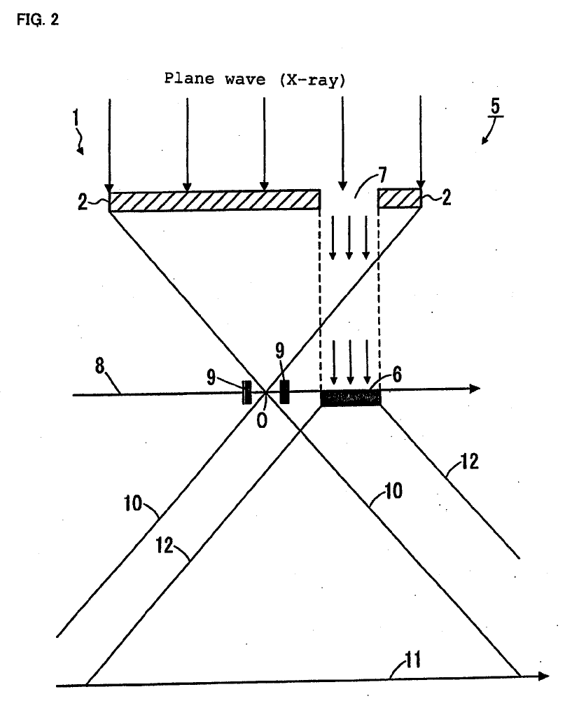

FIG. 3 is a diagram showing an example of a Fourier transform holography imaging system using a conventional Fresnel's zone plate as a beam splitter.

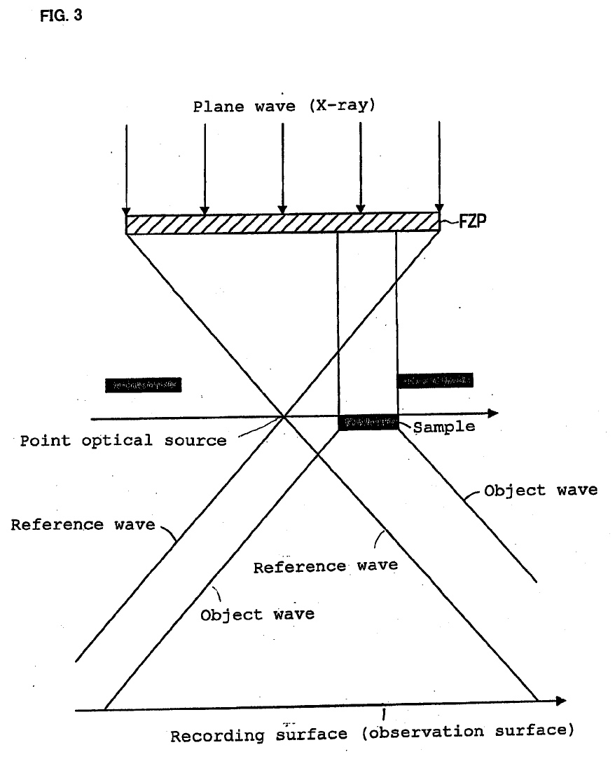

FIG. 4 is a plan view showing a modification of a Fresnel's zone plate according to one embodiment of the present invention.

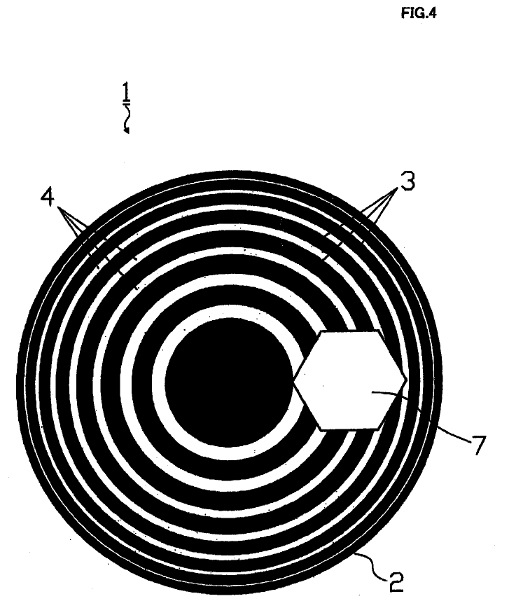

FIG. 5 is a plan view showing a modification of a Fresnel's zone plate according to one embodiment of the present invention.

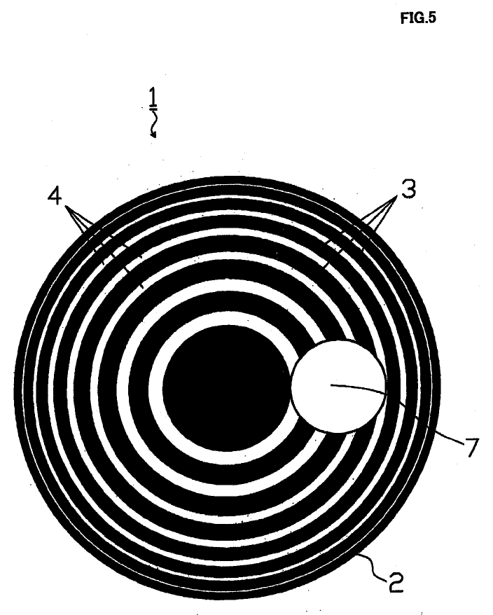

FIG. 6 is a plan view showing a modification of a Fresnel's zone plate according to one embodiment of the present invention.

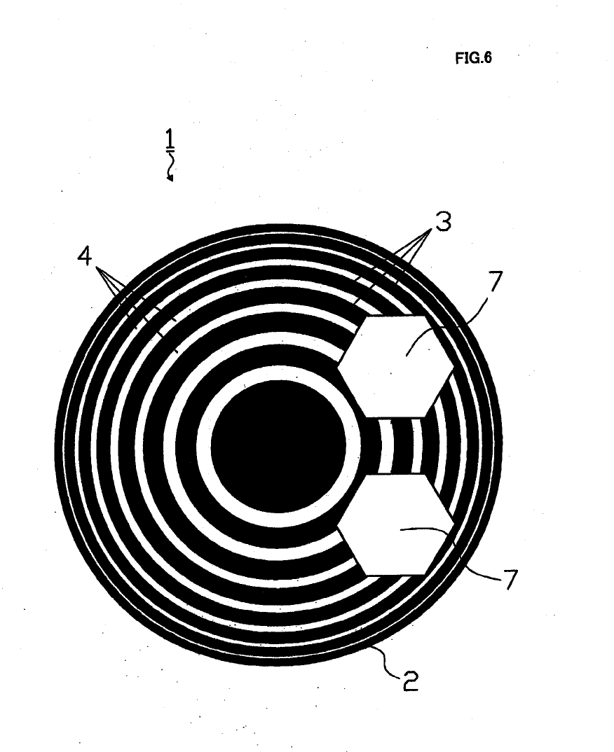

FIG. 7 is a plan view showing a modification of a Fresnel's zone plate according to one embodiment of the present invention.

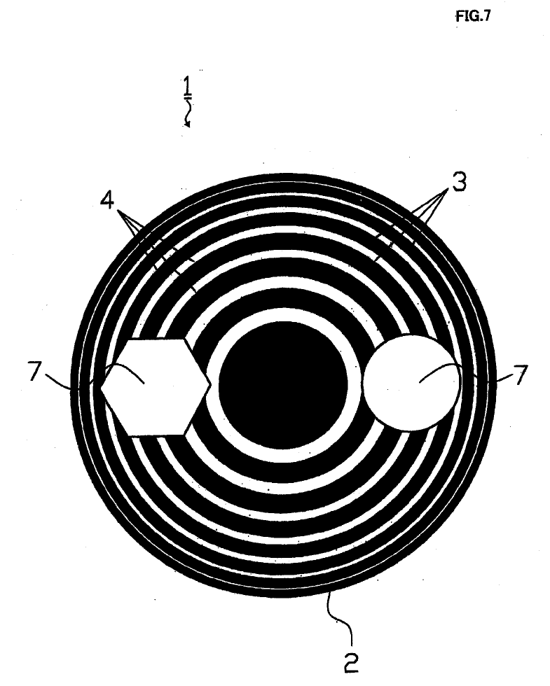

FIG. 8 (a) is a plan view of a Fresnel's zone plate according to a modification of the embodiment, and FIG. 8 (b) is a sectional view taken along the line B-B of FIG. 8 (a).

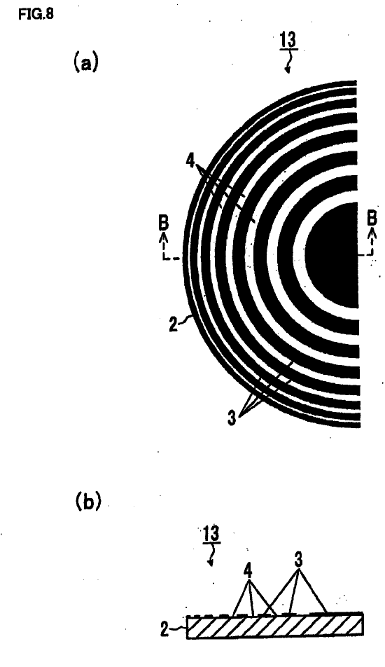

FIG. 9 is a diagram schematically showing an optical system of an X-ray microscope using the Fresnel's zone plate according to the modification as a complex illumination lens.

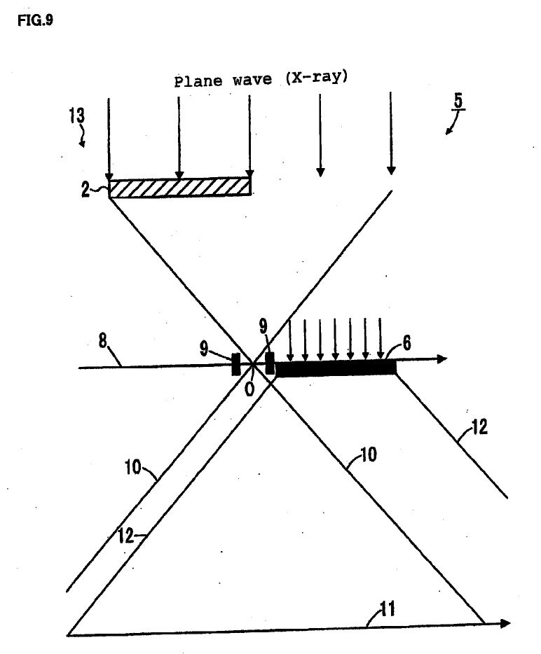

FIG. 10 is a plan view showing a modification of a Fresnel's zone plate according to one embodiment of the present invention.

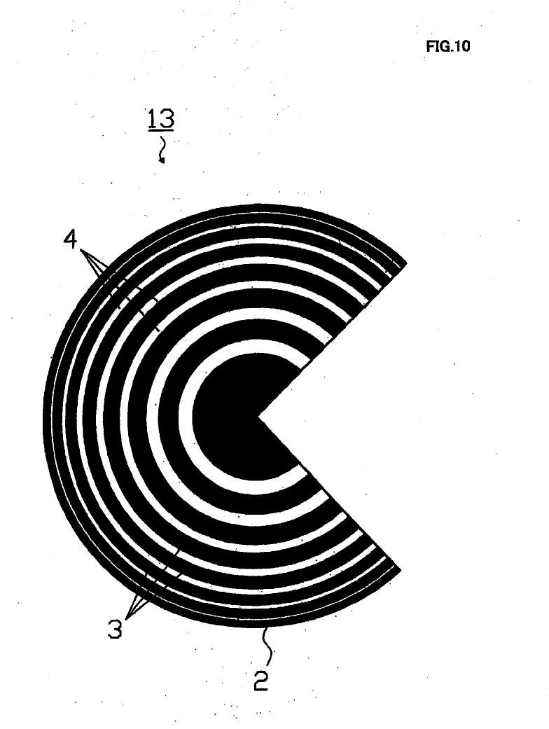

FIG. 11 is a plan view showing a modification of a Fresnel's zone plate according to one embodiment of the present invention.

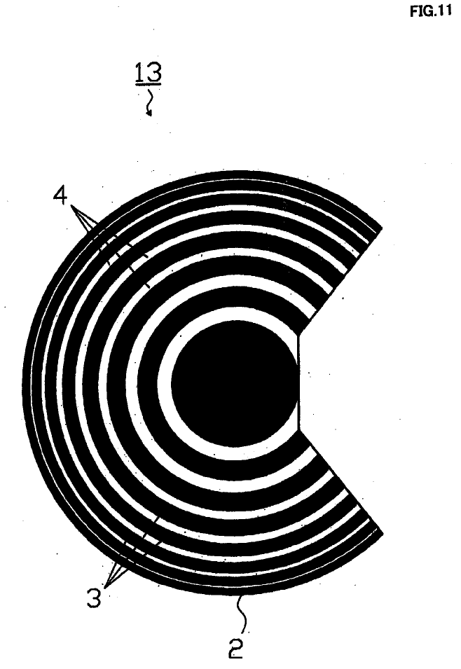

FIG. 12 is a plan view showing a modification of a Fresnel's zone plate according to one embodiment of the present invention.

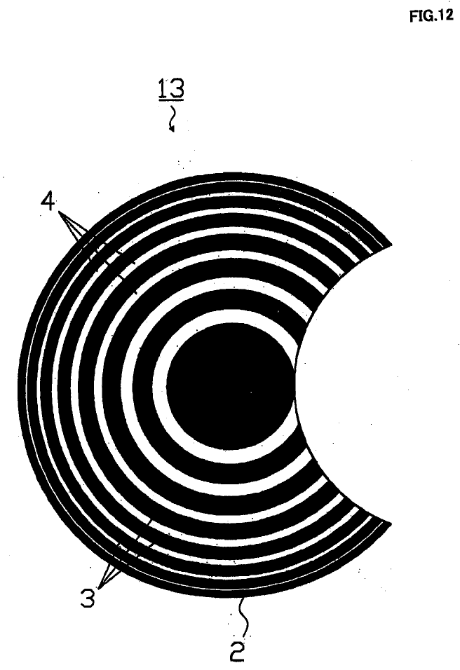

FIG. 13 is a plan view showing a modification of a Fresnel's zone plate according to one embodiment of the present invention.

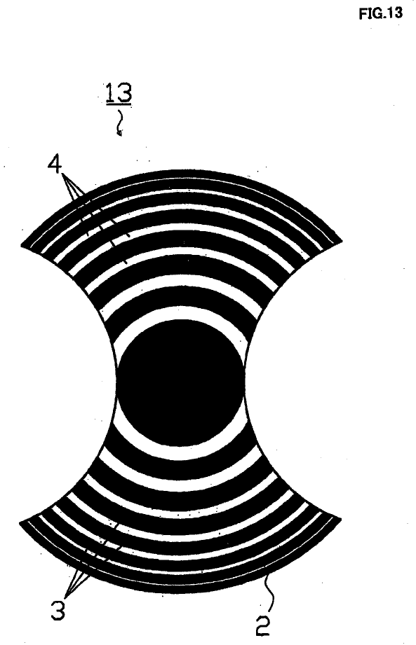

FIG. 14 is a plan view showing a modification of a Fresnel's zone plate according to one embodiment of the present invention.

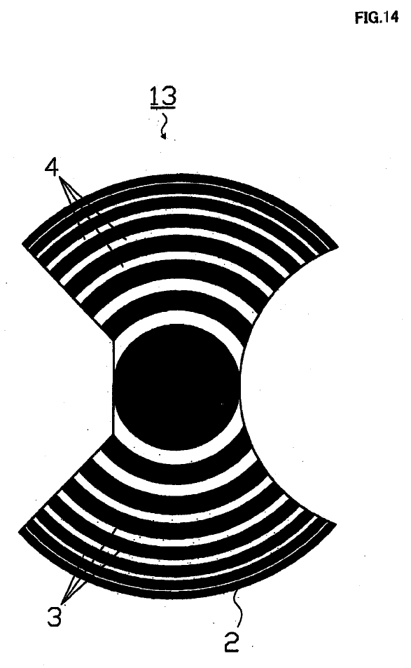

FIG. 15 is a plan view showing a modification of a Fresnel's zone plate according to one embodiment of the present invention.

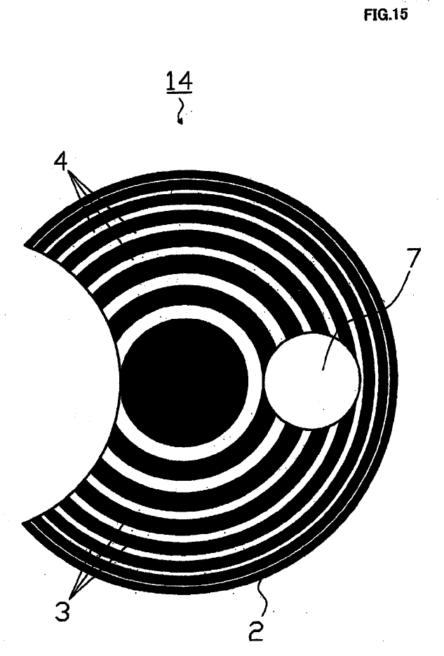

FIG. 16 is a plan view showing a modification of a Fresnel's zone plate according to one embodiment of the present invention.

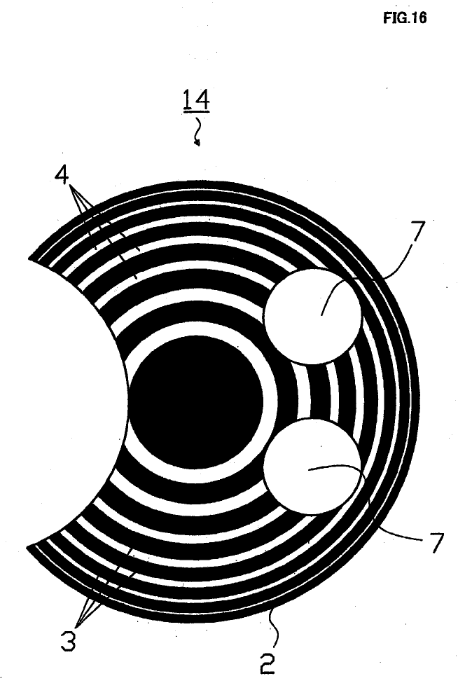

FIG. 17 is a plan view showing a modification of a Fresnel's zone plate according to one embodiment of the present invention.

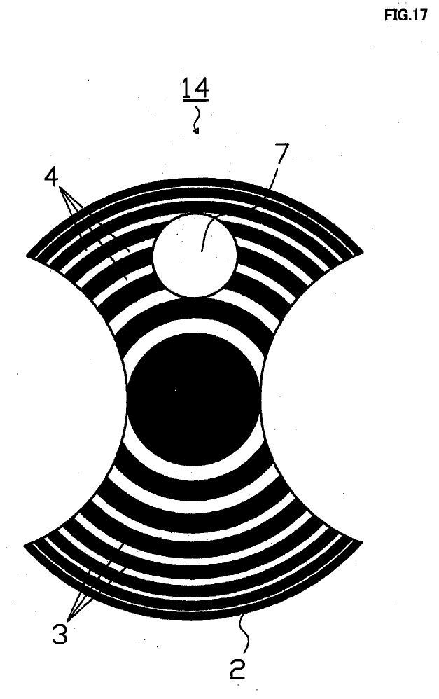

FIG. 18 is a plan view showing a modification of a Fresnel's zone plate according to one embodiment of the present invention.

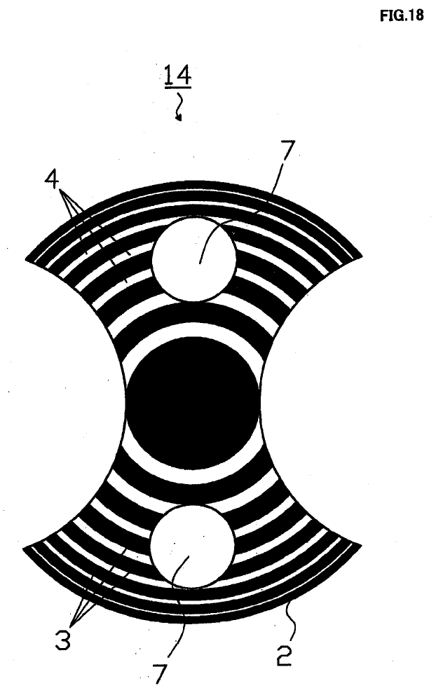

FIG. 19 is a plan view showing a conventional Fresnel's zone plate.

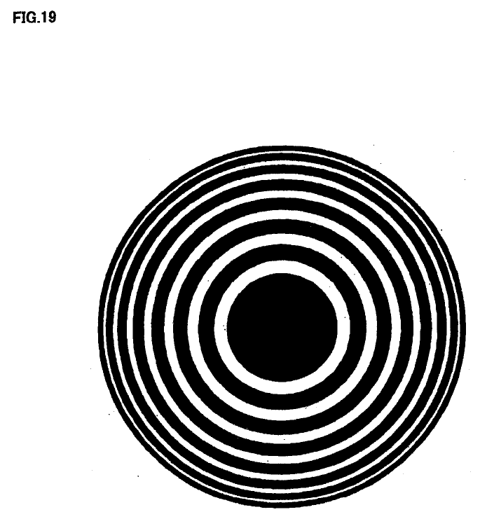

### EXPLANATION OF REFERENCE NUMERALS

1, 13, 14 Fresnel's zone plate
2 transparent substrate
3 opaque band
4 transparent band
5 X-ray microscope
6 sample
7 transmission window

1. A Fresnel's zone plate having a complex illumination function, wherein a transmission window is formed in the Fresnel's zone plate such that a portion of a plane wave vertically applied onto the upper surface of the Fresnel's zone plate directly and vertically enters a sample disposed below the Fresnel's zone plate without being disturbed by the Fresnel's zone plate, the Fresnel's zone plate being formed by concentrically arranging an opaque band and a transparent band alternately in a radial direction from the center on a flat transparent substrate.

2. A Fresnel's zone plate having a complex illumination function, wherein a portion of the Fresnel's zone plate is excised in an axial direction such that a portion of a plane wave vertically applied onto the upper surface of the Fresnel's zone plate directly and vertically enters a sample disposed below the Fresnel's zone plate without being disturbed by the Fresnel's zone plate, the Fresnel's zone plate being formed by concentrically arranging an opaque band and a transparent band alternately in a radial direction from the center on a flat transparent substrate.

3. A Fresnel's zone plate having a complex illumination function, wherein a transmission window is formed in the Fresnel's zone plate and a portion of the Fresnel's zone plate is excised in an axial direction such that a portion of a plane wave vertically applied onto the upper surface of the Fresnel's zone plate directly and vertically enters a sample disposed below the Fresnel's zone plate without being disturbed by the Fresnel's zone plate, the Fresnel's zone plate being formed by concentrically arranging an opaque band and a transparent band alternately in a radial direction from the center on a flat transparent substrate.

4. The Fresnel's zone plate having a complex illumination function according to claim 1 or 3, wherein the transmission window is formed by not disposing the opaque band.

5. The Fresnel's zone plate having a complex illumination function according to claim 1 or 3, wherein the transmission window is formed by providing a face-excised portion in the transparent substrate.

6. The Fresnel's zone plate having a complex illumination function according to any one of claims 1, 3, 4 and 5, wherein the transmission window is polygonal.

7. The Fresnel's zone plate having a complex illumination function according to any one of claims 1, 3, 4 and 5, wherein the transmission window is circular.

8. The Fresnel's zone plate having a complex illumination function according to any one of claims 1, 3, and 4 to 7, wherein two or more transmission windows are formed.

9. The Fresnel's zone plate having a complex illumination function according to claim 1 or 3, wherein two or more transmission windows are formed, and at least one of the transmission windows is formed by not disposing the opaque band while at least one of the transmission windows is formed by providing a face-excised portion in the transparent substrate.

10. The Fresnel's zone plate having a complex illumination function according to claim 1 or 3, wherein two or more transmission windows are formed, and at least one of the transmission windows is polygonal while at least one of the transmission windows is circular.

11. The Fresnel's zone plate having a complex illumination function according to claim 1 or 3, wherein two or more transmission windows are formed, at least one of the transmission windows is formed by not disposing the opaque band while at least one of the transmission windows is formed by providing a face-excised portion in the transparent substrate, and at least one of the transmission windows is polygonal while at least one of the transmission windows is circular.

12. The Fresnel's zone plate having a complex illumination function according to claim 2 or 3, wherein the excised portion of the Fresnel's zone plate is an approximately half of the Fresnel's zone plate that is zoned by a straight line passing through the approximate center of the Fresnel's zone plate.

13. The Fresnel's zone plate having a complex illumination function according to claim 2 or 3, wherein the excised portion of the Fresnel's zone plate is a part of the Fresnel's zone plate that is zoned by a polygon including a part of a circumference of the Fresnel's zone plate.

14. The Fresnel's zone plate having a complex illumination function according to claim 2 or 3, wherein the excised portion of the Fresnel's zone plate is a part of the Fresnel's zone plate that is zoned by a part of a circumference of the Fresnel's zone plate and a circular arc.

15. The Fresnel's zone plate having a complex illumination function according to any one of claims 2, 3, 13 and 14, wherein portions of the Fresnel's zone plate are excised in two or more positions.

16. The Fresnel's zone plate having a complex illumination function according to claim 2 or 3, wherein portions of the Fresnel's zone plate are excised in two or more positions, and at least one of the excised portions is a part of the Fresnel's zone plate that is zoned by a polygon including a part of a circumference of the Fresnel's zone plate while at least one of the excised portions is a part of the Fresnel's zone plate that is zoned by a part of the circumference of the Fresnel's zone plate and a circular arc.

17. An X-ray microscope with no objective lens, using one or more Fresnel's zone plate(s) each having a complex illumination function according to any one of claims 1 to 16 as a complex illumination lens.
